(19) United States
(12) Patent Application Publication
(10) Pub. No.: US 2026/0138371 A1
(43) Pub. Date: May 21, 2026

(54) PRINTING DEVICE

(71) Applicant: SEIKO EPSON CORPORATION, Tokyo (JP)

(72) Inventors: Kazutoshi FUJISHIMA, AZUMINO-SHI (JP); Toshihiro YOKOZAWA, SHIOJIRI-SHI (JP); Shigenori NAKAGAWA, BANGALORE (IN); Kaoru KOIKE, MATSUMOTO-SHI (JP)

(21) Appl. No.: 19/347,823

(22) Filed: Oct. 2, 2025

(30) Foreign Application Priority Data
Oct. 4, 2024 (JP) 2024-175185

(51) Int. Cl. B41J 2/175; B41J 2/17

(52) U.S. Cl. CPC B41J 2/17563; B41J 2/1707; B41J 2/1721; B41J 2/17566

(57) ABSTRACT

A printing device includes: a printing unit that ejects an ink containing a valuable material and thus performs printing on a medium; an ink collecting unit that can collect the ink ejected by the printing unit; a separation unit that separates the valuable material contained in the ink collected by the ink collecting unit; and a valuable material collecting unit that collects the valuable material separated by the separation unit.

The present application is based on, and claims priority from JP Application Serial Number 2024-175185, filed Oct. 4, 2024, the disclosure of which is hereby incorporated by reference herein in its entirety.

### BACKGROUND

### 1. Technical Field

The present disclosure relates to a printing device.

### 2. Related Art

According to the related art, various printing devices that eject an ink from a printing unit and thus print an image on a medium are used. Among these printing devices, there is a printing device that can collect a waste liquid generated by using the printing device. For example, JP-A-2022-83155 discloses a configuration in which a cleaning liquid is used to clean a conveyance belt that conveys a fabric in a printing system that ejects an ink onto the fabric to perform printing. In the printing system of JP-A-2022-83155, the cleaning liquid after cleaning the conveyance belt is mixed with the ink and collected as a waste liquid.

JP-A-2022-83155 discloses that the printing system separates the ink component from the cleaning liquid after cleaning in order to reuse the cleaning liquid. Specifically, the printing system of JP-A-2022-83155 includes a printing device and a processing device, and a cleaning unit for the conveyance belt cleans a conveyance unit that conveys a medium, using the cleaning liquid. Then, the cleaning liquid after cleaning is moved to an aggregation tank of the processing device, is stirred with an aggregating agent, and is separated from an aggregated material. It is assumed that the ink component separated from the cleaning liquid is discarded.

JP-A-2022-83155 is an example of the related art.

Meanwhile, inks contain various materials. Some inks contain a valuable material such as a rare metal. Valuable materials such as a rare metal have a scarcity value and are often expensive. Therefore, in a printing device using an ink containing a valuable material such as a rare metal, it is desired to separate and collect the valuable material from a waste ink, which is an ink not ejected onto a medium.

### SUMMARY

According to an aspect of the present disclosure, a printing device includes: a printing unit configured to eject an ink containing a valuable material and thus perform printing on a medium; an ink collecting unit configured to be able to collect the ink ejected by the printing unit; a separation unit configured to separate the valuable material contained in the ink collected by the ink collecting unit; and a valuable material collecting unit configured to collect the valuable material separated by the separation unit.

### BRIEF DESCRIPTION OF THE DRAWINGS

FIG. 1 is a schematic side view illustrating a printing device according to Example 1 of the present disclosure.

FIG. 2 is a block diagram showing a main part of the printing device shown in FIG. 1.

FIG. 3 illustrates an example of a business model using the printing device shown in FIG. 1.

FIG. 4 is a block diagram showing a main part of a printing device according to Example 2 of the present disclosure.

### DESCRIPTION OF EMBODIMENTS

First, the present disclosure will schematically be described.

According to a first aspect of the present disclosure, a printing device includes: a printing unit configured to eject an ink containing a valuable material and thus perform printing on a medium; an ink collecting unit configured to be able to collect the ink ejected by the printing unit; a separation unit configured to separate the valuable material contained in the ink collected by the ink collecting unit; and a valuable material collecting unit configured to collect the valuable material separated by the separation unit.

According to the present aspect, the printing device includes the separation unit, which separates the valuable material contained in the ink collected by the ink collecting unit, and the valuable material collecting unit, which collects the valuable material separated by the separation unit. Therefore, in the printing device that ejects an ink containing a valuable material such as a rare metal, the valuable material can be separated by the separation unit from waste ink, which is an ink not ejected onto a medium, and can be collected by the valuable material collecting unit.

According to a second aspect of the present disclosure, in the printing device according to the first aspect, the ink includes a first ink containing the valuable material and a second ink not containing the valuable material, and the ink collecting unit is configured to be able to separately collect the first ink and the second ink.

According to the present aspect, the ink collecting unit is configured to be able to separately collect the first ink containing the valuable material and the second ink not containing the valuable material. Therefore, the valuable material can be efficiently separated and collected from the waste ink of the first ink, which is not ejected to the medium.

According to a third aspect of the present disclosure, the printing device according to the first or second aspect further includes a calculation unit configured to calculate an amount of the valuable material collected by the valuable material collecting unit.

According to the present aspect, the printing device includes the calculation unit, which calculates the amount of the valuable material collected by the valuable material collecting unit. Therefore, the amount of the valuable material collected by the valuable material collecting unit can be properly checked.

According to a fourth aspect of the present disclosure, the printing device according to the third aspect further includes a maintenance unit configured to perform flushing of the ink from the printing unit and cleaning of the printing unit, and the calculation unit performs the calculation, based on at least one of an amount of use of the ink ejected to an image printed by the printing unit, a number of times of flushing of the ink, and a number of times of cleaning of the printing unit ejecting the ink.

According to the present aspect, the calculation unit performs the calculation, based on at least one of the amount of use of the ink ejected to the image printed by the printing unit, the number of times of flushing of the ink, and the number of times of cleaning of the printing unit that ejects the ink. As the amount of the valuable material collected by the valuable material collecting unit is calculated based on these data, the amount of the valuable material can be accurately calculated.

According to a fifth aspect of the present disclosure, in the printing device according to the aspect according to the third aspect, the valuable material collecting unit is provided to be detachable from the printing device, and the printing device includes a notification unit configured to notify replacement of the valuable material collecting unit when the amount of the valuable material calculated by the calculation unit exceeds a threshold.

According to the present aspect, the valuable material collecting unit is provided to be detachable from the printing device, and the notification unit notifies replacement of the valuable material collecting unit when the calculated amount of the valuable material exceeds the threshold. Therefore, the valuable material can be efficiently collected.

### EXAMPLE 1

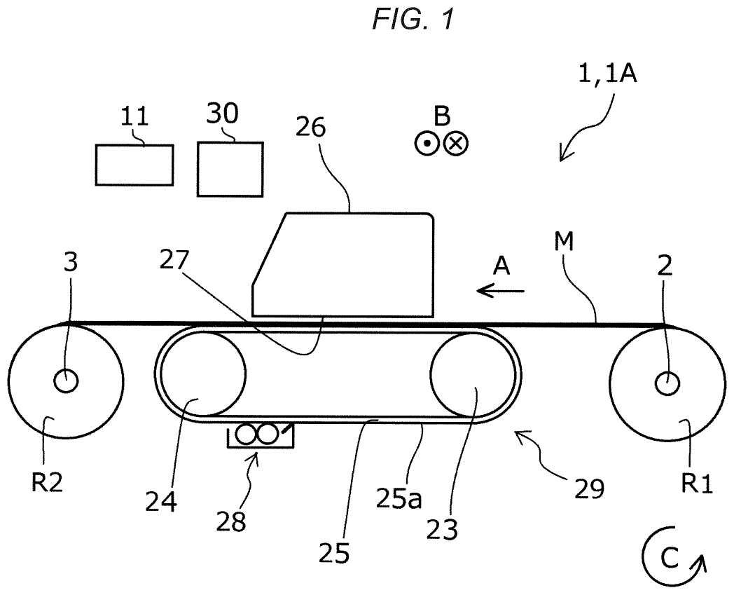

Embodiments according to the present disclosure will now be described with reference to the accompanying drawings. First, an outline of a printing device 1A according to Example 1 as an example of a printing device 1 according to the present disclosure will be described with reference to FIG. 1. As illustrated in FIG. 1, the printing device 1A according to the present example includes a control unit 11. The control unit 11 includes a CPU, a storage unit, and the like, not illustrated, and controls the driving of each component member of the printing device 1A. Also, the printing device 1A includes a panel 30 that can notify various information in the printing device 1A and can input various instructions to the printing device 1A.

As illustrated in FIG. 1, the printing device 1A according to the present example includes a holding unit 2 that can rotatably hold a roll body R1 around which a medium M such as a fabric is wound in a roll shape. Also, a conveyance unit 29 that conveys the medium M and a head 27 as a printing unit that ejects an ink onto the medium M conveyed by the conveyance unit 29 and thus prints an image thereon are provided. Also, a take-up unit 3 that winds the printed medium M in a roll shape and thus can form a roll body R2 is provided.

The holding unit 2 holds a paper tube forming a rotation shaft of the roll body R1, and can rotate in a direction of rotation C and thus feed the medium M from the roll body R1 to the conveyance unit 29 of the printing device 1A. The holding unit 2 may be configured separately from the printing device 1A but may be a part of the component members of the printing device 1A.

The printing device 1A according to the present example is an inkjet printer that ejects an ink, which is a liquid, in the form of droplets, and thus can form an image on the medium M. The printing device 1A includes, as the conveyance unit 29, a driven roller 23 located upstream in a direction of conveyance A, which is the direction of conveyance of the medium M, a drive roller 24 located downstream in the direction of conveyance A, and a conveyance belt 25, which is an endless belt stretched between the driven roller 23 and the drive roller 24. The conveyance belt 25 is an adhesive belt having an outer circumferential surface 25a, which is an outer surface and a support surface for the medium M, coated with a pressure-sensitive adhesive.

As illustrated in FIG. 1, in the conveyance unit 29, the medium M is supported and conveyed by the conveyance belt 25 in a state where the medium M is attached to the outer circumferential surface 25a. In the printing device 1A according to the present example, a medium support region for supporting the medium M, of the conveyance belt 25, is an upper region extending between the driven roller 23 and the drive roller 24. Also, the drive roller 24 is a roller that rotates in the direction of rotation C by a driving force of a motor, not illustrated, and the driven roller 23 is a roller that is driven by the turning of the conveyance belt 25 due to the rotation of the drive roller 24 and thus rotates.

That is, the direction of movement of the conveyance belt 25 when conveying the medium M is the direction of rotation C, and the direction of movement of the conveyance belt 25 in the medium support region is the direction of conveyance A. However, at other times than when conveying the medium M, the drive roller 24 can be rotated in the direction opposite to the direction of rotation C and the conveyance belt 25 can thus be moved in the direction opposite to the direction of rotation C.

The printing device 1A according to the present example also includes a carriage 26 that can move forward and backward in a width direction B of the conveyance belt 25, and the head 27 attached to the carriage 26. The head 27 is a printing unit that ejects a liquid ink onto the medium M conveyed in the direction of conveyance A, based on print data, and thus can form an image thereon. The printing device 1A according to the present example also includes a cleaning unit 28 that cleans the conveyance belt 25 downstream of the head 27 in the direction of rotation C, which is the direction of movement of the conveyance belt 25.

The printing device 1A according to the present example ejects an ink from the head 27 onto the conveyed medium M while moving the carriage 26 forward and backward in the width direction B intersecting the direction of conveyance A, and thus can form an image thereon. Since the carriage 26 having such a configuration is provided, the printing device 1A according to the present example repeats conveying the medium M in the direction of conveyance A by a predetermined amount of conveyance and ejecting an ink while moving the carriage 26 in the width direction B in a state where the medium M is stopped, and thus can form a desired image on the medium M. However, the configuration of the printing unit is not particularly limited. For example, a so-called line head in which nozzles that eject an ink are provided over the entire width direction B of the medium M may be used as the printing unit.

As described above, the printing device 1A according to the present example includes the take-up unit 3. The medium M on which an image is formed by ejecting an ink from the head 27 is wound up as the roll body R2 by the take-up unit 3. The take-up unit 3 holds a paper tube as a rotation shaft for forming the roll body 2, rotates in the direction of rotation C to wind up the medium M around the paper tube, and thus can form the roll body R2. The take-up unit 3 may be configured separately from the printing device 1A but may be a part of the component members of the printing device 1A. A drying device or the like for drying the ink ejected onto the medium M may be provided between the take-up unit 3 and the printing device 1A.

As the medium M, a material for textile printing can be preferably used. The material for textile printing refers to a fabric, clothes, other clothing products, and the like on which textile printing is to be performed. Examples of the fabric include woven fabrics, knitted fabrics, and nonwoven fabrics of natural fibers such as cotton, silk, and wool, chemical fibers such as nylon, or composite fibers, which are mixtures of these fibers. Also, the clothes and other clothing products include sewn T-shirts, handkerchiefs, scarves, towels, handbags, cloth bags, and furniture fabric products such as curtains, bed sheets, and bed covers, as well as fabrics before and after cutting that are present as parts before sewing. However, in addition to the material for textile printing, a special paper for inkjet recording such as a normal paper, a high-quality paper, and a glossy paper can also be used.

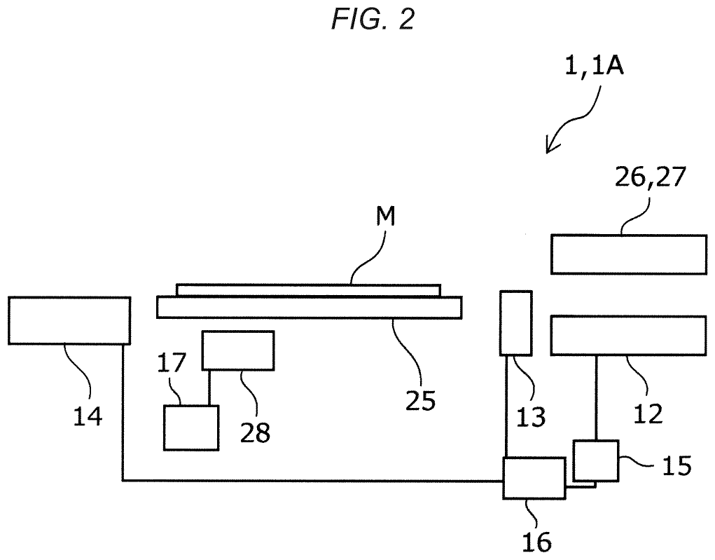

The printing device 1A according to the present example will be further described below with reference to FIG. 2. As illustrated in FIG. 2, the printing device 1A according to the present example includes a cap 12 that can cover the nozzle forming surface of the head 27 when the print processing is not executed. The ink can be sucked from the nozzles of the head 27 by a suction unit 15 via the cap 12. Also, a wiper 13 that can wipe the nozzle forming surface of the head 27 is provided. Also, a flushing plate 14 serving as a tray when flushing the ink from the nozzles of the head 27 is provided. Also, a circulation mechanism, not illustrated, is provided which circulates the ink in the carriage 26 or the like so that an ink component does not settle in the nozzles of the head 27. The cap 12, the wiper 13, the flushing plate 14, the suction unit 15, and the circulation mechanism form a maintenance unit of the head 27.

Moreover, as illustrated in FIG. 2, the printing device 1A according to the present example includes a first collecting unit 16 that collects the ink collected by the cap 12, the wiper 13, and the flushing plate 14. Also, a second collecting unit 17 that collects a precipitate due to the ink component collected by the cleaning unit 28 is provided. The printing device 1A according to the present example is configured to be able to use an ink containing a valuable material such as a rare metal. The ink for printing on a fabric as the medium M may contain a valuable material such as a rare metal.

That is, the printing device 1A according to the present example includes the head 27 that ejects an ink containing a valuable material and thus performs printing on the medium M, and the first collecting unit 16 and the second collecting unit 17 as ink collecting units that can collect the ink ejected by the head 27. The first collecting unit 16 and the second collecting unit 17 also serve as a separation unit that separates the valuable material contained in the collected ink, and also serve as a valuable material collecting unit that collects the separated valuable material. The first collecting unit 16 and the second collecting unit 17 are configured to allow the valuable material contained in the collected ink to settle in a precipitation tank, not illustrated, and thus separate the valuable material, but may separate the valuable material by centrifuging the collected ink.

With such a configuration, the printing device 1A according to the present example can separate and collect a valuable material from the waste ink, which is an ink not ejected onto the medium M, in the printing device 1 ejecting an ink containing a valuable material such as a rare metal. In the printing device 1A according to the present example, the first collecting unit 16 and the second collecting unit 17 as the ink collecting unit also serve as the separation unit and serve as the valuable material collecting unit, but at least one of the separation unit and the valuable material collecting unit may be configured separately from the ink collecting unit.

In the printing device 1A according to the present example, the control unit 11 can calculate the amount of the valuable material collected by the first collecting unit 16 and the second collecting unit 17. As the calculation unit (control unit 11) calculating the amount of the valuable material collected by the valuable material collecting unit is provided in this way, the amount of the valuable material collected by the valuable material collecting unit can be properly checked.

As described above, the printing device 1A according to the present example includes the maintenance unit configured to be able to flush the ink from the head 27 and clean the head 27. Specifically, in the printing device 1A according to the present example, the control unit 11 calculates the amount of the valuable material, based on the amount of use of the ink ejected to the image printed by the head 27, the number of times of ink flushing, and the number of times of cleaning of the head 27 ejecting the ink.

As described above, the control unit 11 as the calculation unit may preferably perform the calculation, based on at least one of the amount of use of the ink ejected to the image printed by the head 27, the number of times of ink flushing, and the number of times of cleaning of the head 27 ejecting the ink. This is because the amount of the valuable material can be accurately calculated by calculating the amount of the valuable material collected by the valuable material collecting unit, based on these data.

In the printing device 1A according to the present example, the first collecting unit 16 and the second collecting unit 17 as the valuable material collecting unit are provided to be detachable from the printing device 1. The printing device 1A according to the present example is configured to be able to cause the panel 30 to notify the replacement of the first collecting unit 16 and the second collecting unit 17 when the amount of the valuable material calculated by the control unit 11 exceeds a threshold. Since the valuable material collecting unit is provided to be detachable from the printing device 1 and the notification unit is configured to notify the replacement of the valuable material collecting unit when the calculated amount of the valuable material exceeds the threshold as described above, the valuable material can be efficiently collected.

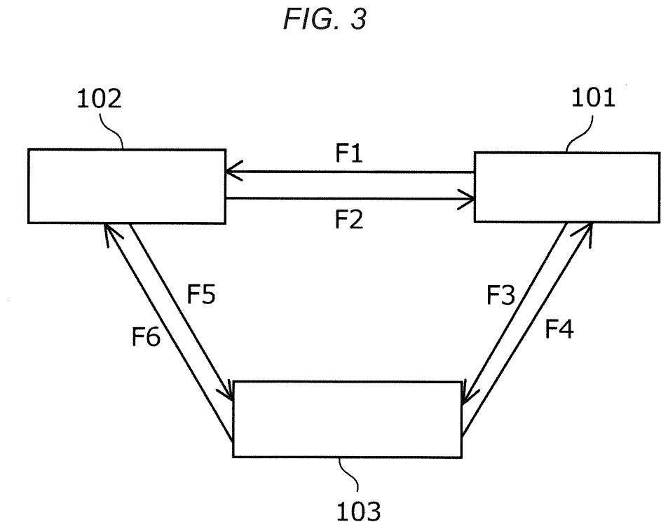

An example of a business model using the printing device 1A according to the present example will now be described with reference to FIG. 3. FIG. 3 illustrates an example of a business model involving a manufacturer or seller 101 of the printing device 1, a user 102, and a valuable material purchase company 103. Such a business model has advantages in that a discount on the ink, to be more precise, a discount on the ink cartridge, is properly made to the user 102, that the timing of collecting the valuable material by the valuable material purchase company 103 is optimized, and that customer attrition from the manufacturer or seller 101 of the printing device 1 can be suppressed.

In FIG. 3, an arrow F1 from the manufacturer or seller 101 of the printing device 1 to the user 102 represents a discount on the ink (discount on the ink cartridge) used in the printing device 1. An arrow F2 from the user 102 to the manufacturer or seller 101 of the printing device 1 represents various data such as the amount of the ink used by the printing device 1, the number of times of ink flushing, and the number of times of cleaning of the head 27 ejecting the ink. An arrow F3 from the manufacturer or seller 101 of the printing device 1 to the valuable material purchase company 103 represents information such as the type and the unit price of the valuable material. An arrow F4 from the valuable material purchase company 103 to the manufacturer or seller 101 of the printing device 1 represents information on the purchase price of the valuable material and the amount of the valuable material purchased. An arrow F5 from the user 102 to the valuable material purchase company 103 represents pick-up information about the valuable material. An arrow F6 from the valuable material purchase company 103 to the user 102 represents information about the timing of visit associated with the purchase of the valuable material.

Specifically, the valuable material is calculated in the following manner and provides a financial resource for monetization, that is, a financial resource for the discount on the ink cartridge. “Predicted amount of waste collected×content rate of valuable material×market value of valuable material=discount amount of ink cartridge” and “amount of valuable material purchased ×market value of valuable material=purchase price”. It is preferable that “discount amount of ink cartridge<purchase price” is satisfied so that a loss does not occur to the manufacturer or seller 101 of the printing device 1.

With such a business model, expensive rare metal components and the like can be collected and reused and the waste ink can be reduced. Also, the ink containing expensive rare metal components and the like can be collected while an approximate amount of the ink collected is calculated. Also, expensive rare metal components can be collected from the precipitate in the cleaning tank while the waste water or the like in the cleaning tank in the cleaning unit 28 is reduced and minimized. Moreover, waste materials (valuable materials such as rare metal components) can be collected at an optimum collection timing and can be turned into a reward to the user 102 in the form of a discount on the ink cartridge or the like.

### EXAMPLE 2

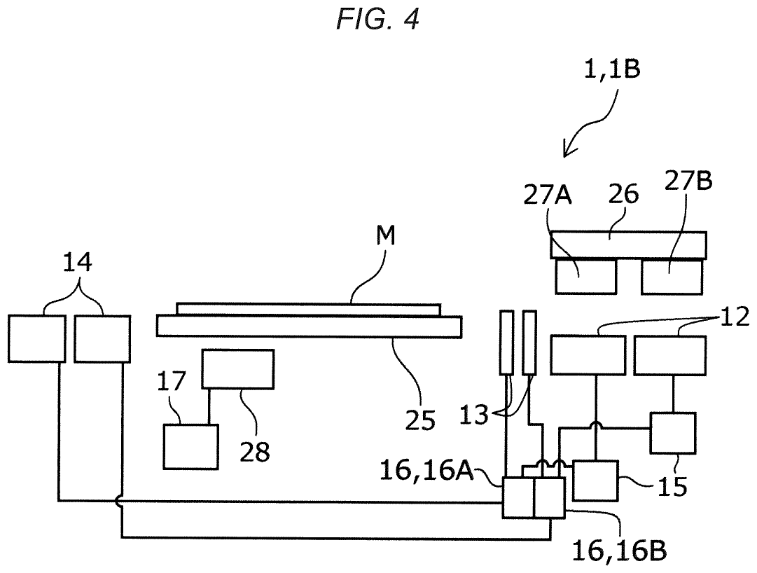

Next, a printing device 1B according to Example 2 will be described with reference to FIG. 4. FIG. 4 is a diagram corresponding to FIG. 2 for the printing device 1A according to Example 1. In FIG. 4, the component members common with the above-described Example 1 are denoted by the same reference signs and the detailed explanation thereof will be omitted. The printing device 1B according to the present example has a configuration similar to that of the printing device 1A according to Example 1 except for the parts described below. Therefore, the printing device 1B according to the present example has features similar as those of the printing device 1A according to Example 1 except for the parts described below.

As illustrated in FIG. 4, the printing device 1B according to the present example includes two heads 27, that is, a first head 27A and a second head 27B in the carriage 26. Of these, the first head 27A is a head 27 that can eject a first ink containing a valuable material, and the second head 27B is a head 27 that can eject a second ink not containing a valuable material.

That is, the printing device 1B according to the present example includes the first ink containing a valuable material and the second ink not containing a valuable material, as inks that can be ejected from the head 27. The printing device 1B according to the present example is provided with two caps 12, two wipers 13, two flushing plates 14, two suction units 15, and two first collecting units 16 for the first ink and the second ink. The first collecting units 16, which are the ink collecting units of the printing device 1B according to the present example, are separated as a first ink collecting unit 16A that collects the first ink and a second ink collecting unit 16B that collects the second ink. The first ink collecting unit 16A of the printing device 1B according to the present example has a configuration similar to the first collecting unit 16 of the printing device 1A according to Example 1 and also serves as a separation unit and a valuable material collecting unit.

With such a configuration, the first collecting units 16 of the printing device 1B according to the present example are configured to be able to separately collect the first ink containing the valuable material and the second ink not containing the valuable material. Therefore, the printing device 1B according to the present example can efficiently separate and collect the valuable material from the waste ink of the first ink that is not ejected onto the medium M.

The present disclosure is not limited to the above-described examples, and various modifications can be made within the scope of the disclosure described in the claims, and as a matter of course, such modifications are also within the scope of the present disclosure. For example, the printed medium M that is no longer necessary may be defibrated by using the printing device 1 of the above-described examples, and a valuable material such as a rare metal may be separated and collected from this medium M.

What is claimed is:

1. A printing device comprising:
a printing unit configured to eject an ink containing a valuable material and thus perform printing on a medium;
an ink collecting unit configured to be able to collect the ink ejected by the printing unit;
a separation unit configured to separate the valuable material contained in the ink collected by the ink collecting unit; and
a valuable material collecting unit configured to collect the valuable material separated by the separation unit.

2. The printing device according to claim 1, wherein
the ink includes a first ink containing the valuable material and a second ink not containing the valuable material, and
the ink collecting unit is configured to be able to separately collect the first ink and the second ink.

3. The printing device according to claim 1, further comprising:
a calculation unit configured to calculate an amount of the valuable material collected by the valuable material collecting unit.

4. The printing device according to claim 3, further comprising:
a maintenance unit configured to perform flushing of the ink from the printing unit and cleaning of the printing unit, wherein
the calculation unit performs the calculation, based on at least one of an amount of use of the ink ejected to an image printed by the printing unit, a number of times of flushing of the ink, and a number of times of cleaning of the printing unit ejecting the ink.

5. The printing device according to claim 3, wherein
the valuable material collecting unit is provided to be detachable from the printing device, and
the printing device further comprises a notification unit configured to notify replacement of the valuable material collecting unit when the amount of the valuable material calculated by the calculation unit exceeds a threshold.
